(19) United States
(12) Patent Application Publication
(10) Pub. No.: US 2026/0095231 A1
(43) Pub. Date: Apr. 2, 2026

(54) WTRU-INITIATED BEAM REPORTING BASED ON MULTI-EVENT CONFIGURATIONS

(71) Applicant: InterDigital Patent Holdings, Inc., Wilmington, DE (US)

(72) Inventors: Jonghyun Park, Syosset, NY (US); Afshin Haghighat, Ile-Bizard (CA); Moon IL Lee, Melville, NY (US); Virgil Comsa, Montreal (CA); Loic Canonne-Velasquez, Dorval (CA); Mohammad Irfan, Chateauguay (CA)

(73) Assignee: InterDigital Patent Holdings, Inc., Wilmington, DE (US)

(21) Appl. No.: 18/902,817

(22) Filed: Sep. 30, 2024

(51) Int. Cl. H04B 7/06

(52) U.S. Cl. CPC H04B 7/06952; H04B 7/0619

(57) ABSTRACT

A wireless transmit/receive unit (WTRU) configured to receive configuration information with event-based uplink (UL) resource selection. Each UL indication resource of a plurality of UL indication resources in the configuration information is configured for indicating a corresponding one or more applicable events detectable at the WTRU. The WTRU may detect a triggering condition for at least one of the one or more applicable events based on a configured applicable event definition. The WTRU may determine, in response to the triggering condition being detected, the corresponding UL indication resource based on the one or more applicable events in the configuration information. The WTRU may transmit, to a gNB, on the UL indication resource to indicate the detection of the triggering condition for the at least one of the one or more applicable events.

### BACKGROUND

Any kinds of beam or channel state information (CSI) reporting from a wireless transmit/receive unit (WTRU) are performed by a procedure controlled by a gNB. Specifically, the WTRU is configured with measurement resources (Non-Zero-Power Channel State Information Reference Signal (NZP-CSI-RS) resources and/or synchronization signal block (SSB) indexes) including Channel State Information-Interference Measurement (CSI-IM) resources and these are linked to a CSI reporting configuration. Based on the CSI reporting configuration (e.g., periodic, semi-persistent, or aperiodic reporting), the WTRU measures the measurement resources and reports the measurement results via the CSI reporting configuration. For the case of aperiodic reporting, the gNB triggers (by sending a downlink control information (DCI)) the measurement and reporting behavior for the WTRU to conduct. It needs to be further considered for WTRU-initiated beam reporting (WTRU IBR) procedure to reduce the latency and overhead of the current network (NW) NW-initiated methods.

Event-2 “Quality of at least one new beam, such as L1-RSRP, becomes a threshold value better than the current beam” is supported to be applied for the WTRU IBR procedure, where the RS for the current beam is implicitly derived from a QCL RS of indicated TCI state. Besides the Event-2 (for aiding gNB's better decision to update current TCI-state), Event-1 and Event-7 are also supported, where Event-1 (e.g., for early BFD “per-caution” purpose) is that quality of the current beam is worse than a certain threshold, and Event-7 (e.g., for aiding gNB's better decision for activating TCI-states) is that quality of at least one new beam, such as L1-RSRP, becomes a threshold value better than the RS derived from the activated TCI state with the M-th best quality, where M is RRC configured.

### SUMMARY

A wireless transmit/receive unit (WTRU) configured to receive configuration information with event-based uplink (UL) resource selection. Each UL indication resource of a plurality of UL indication resources in the configuration information is configured for indicating a corresponding one or more applicable events detectable at the WTRU. The WTRU may detect a triggering condition for at least one of the one or more applicable events based on a configured applicable event definition. The WTRU may determine, in response to the triggering condition being detected, the corresponding UL indication resource based on the one or more applicable events in the configuration information. The WTRU may transmit, to a gNB, on the UL indication resource to indicate the detection of the triggering condition for the at least one of the one or more applicable events.

The WTRU may receive, in response to the transmission on the UL indication resource, a dedicated UL grant configured to transmit WTRU initiated beam reporting contents. The WTRU may further transmit, based on the received dedicated UL grant, the WTRU initiated beam reporting contents. The WTRU may transmit, in response to the transmission on the UL indication resource, WTRU initiated beam reporting contents. In an example, the WTRU initiated beam reporting contents may include one or more of one beam quality metric (e.g., L1-RSRP) each with the corresponding beam or RS-ID, and/or a channel state information (CSI) report, wherein the CSI report comprises indications for rank indicator (RI), precoding matrix indicator (PMI), or channel quality indicator (CQI).

In one embodiment, each UL indication resource of the plurality of UL indication resources may include a separate physical uplink control channel (PUCCH) resource. Each UL indication resource of the plurality of UL indication resources may be associated with one or more event-IDs and one common scheduling request (SR)-ID. The transmission on the UL indication resource may include one less than a threshold number of bits, such as one bit or two bits. In another example, the one or more applicable events may include an event for checking whether a current beam quality is worse than a threshold.

In one example, the one or more applicable events may include an event for checking whether a current beam quality becomes a threshold value worse than a new beam quality. The one or more applicable events may include an event for checking whether a M-th best activated beam quality becomes a threshold value worse than a new beam quality, and a value of M can be configured.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example of a downlink control information (DCI) field of a DCI for unified transmission configuration indicator (TCI) state indications.

FIG. 3 is a system diagram illustrating WTRU-initiated beam reporting mode A.

FIG. 4 is a system diagram illustrating WTRU-initiated beam reporting mode B.

FIG. 5 is a system diagram illustrating an association of a current beam and a set of candidate new beam.

FIG. 6 is a system diagram illustrating an example of an event associated with a dedicated uplink (UL) resource ID.

FIG. 7 is a system diagram illustrating an example of an event associated with a dedicated PUCCH resource ID.

FIG. 8 is a system diagram illustrating an example of a WTRU-initiated beam reporting procedure based on pre-configured UL resources.

### DETAILED DESCRIPTION

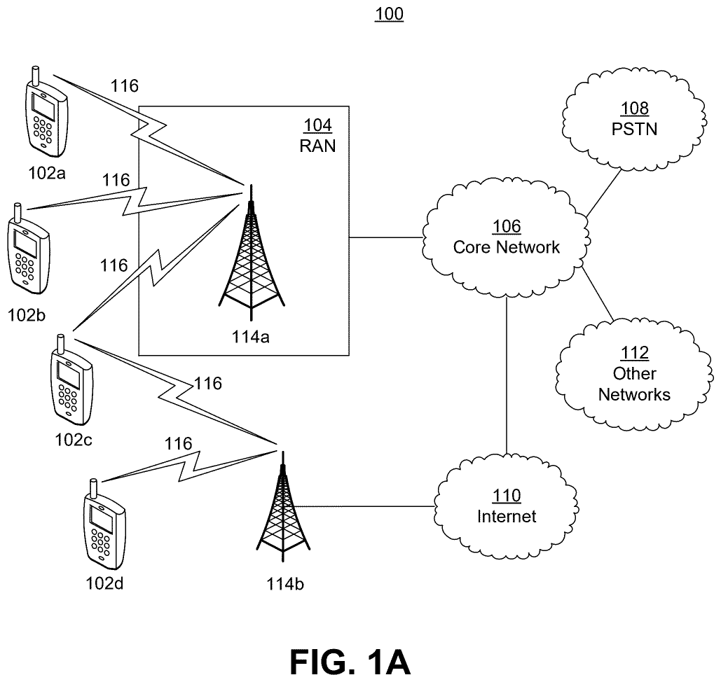

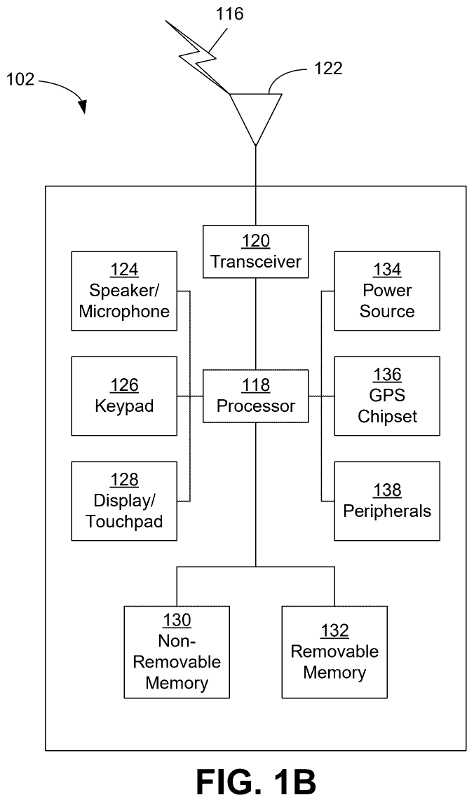

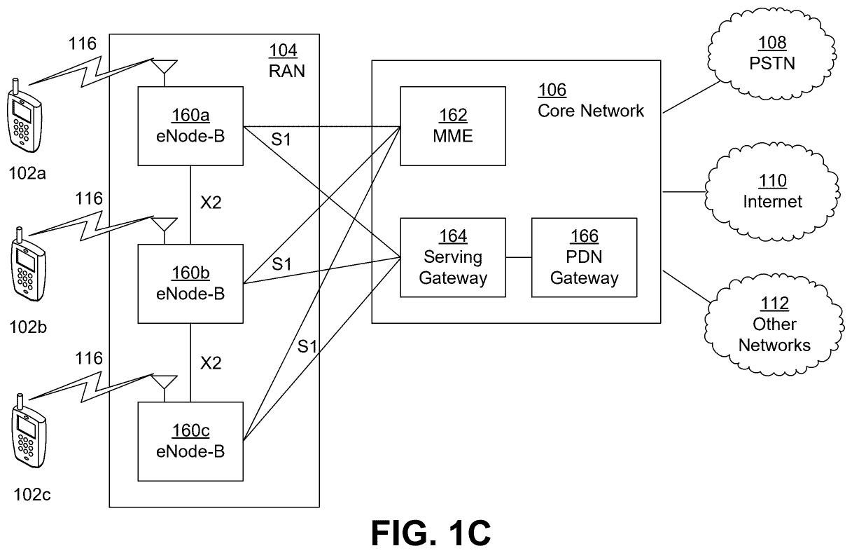

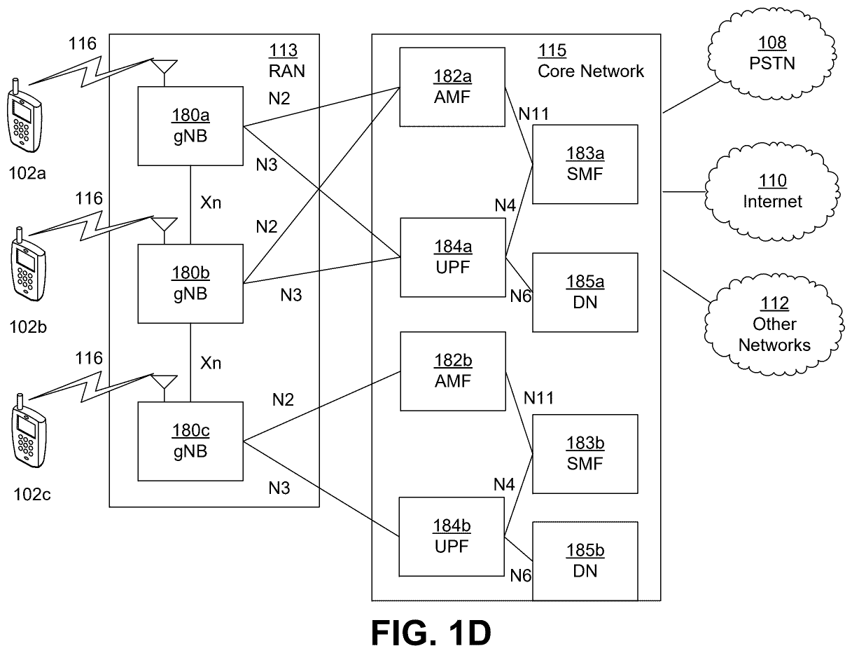

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, functions while being fully or partially implemented and/or deployed as part of a wired and/or wireless communication network in order to test other devices within the communication network. The one or more emulation devices may perform the one or more, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Embodiments are described herein for WTRU initiated beam reporting procedure associated with one or more events and related WTRU behaviors on measurements and reporting contents are described herein. A WTRU may receive configuration of applicable events. Each applicable event may include definitions. For example, Event-1 may be for checking if a current beam quality becomes worse than a threshold. Event-2 may be for checking if a current beam quality becomes a threshold value worse than a new beam quality. Event-7 may be for checking if a M-th best activated beam quality becomes a threshold value worse than a new beam quality, (e.g., where a value of M can be configured).

The WTRU may receive configuration associating an uplink (UL) indication resource to a combination of one or more events. For example, the UL indication resource may be based on multiple PUCCH resources (e.g., each of the multiple PUCCH resources may include a PUCCH resource ID) to be used for delivering a WTRU-initiated beam reporting (WTRU IBR) request (e.g., or notification), where a PUCCH resource of the multiple PUCCH resources may be associated with one or more Event-ID(s) and one common scheduling request (SR)-ID.

In an example, one SR-ID (e.g., SR-ID #7) may be dedicated for the WTRU IBR procedure, and be associated with multiple PUCCH resources. For example, PUCCH-resource ID #1 may be associated with Event-1. PUCCH-resource ID #2 may be associated with Event-2. PUCCH-resource ID #3 may be associated with Event-7. PUCCH-resource ID #4 may be associated with both Event-1 and Event-2 when occurred simultaneously. PUCCH-resource ID #5 may be associated with both Event-2 and Event-7 when occurred simultaneously. PUCCH-resource ID #6 may be associated with Event-1, Event-2, and Event-7 when occurred simultaneously.

The WTRU may determine that a condition for a first one or more events (e.g., the Event-2, and/or the Event-7) is met based on the configured applicable event definition. The WTRU may determine an uplink (UL) indication resource, such as a PUCCH resource ID (e.g., ID #2, ID #3, and/or ID #5), based on the detected first one or more events and the configuration.

The WTRU may transmit the selected UL indication, based on the UL indication resource (e.g., delivering the WTRU IBR request). The WTRU may receive a UL grant (e.g., DCI) for transmitting WTRU IBR contents. The WTRU may transmit, based on the received UL grant, the WTRU IBR contents determined based on the first one or more events.

Given an already allocated resource and configured procedure (e.g., for the Event-2), methods and apparatus are described herein for how to flexibly operate by taking additional events (e.g., the Event-7 or 1) into account, without having extra overhead for increasing UL resources to deliver multi-event-based beam reporting are described herein. In other words, methods and apparatus are described herein for how multiple different events can be concurrently checked and triggered, while minimizing the increase in UL resource overhead for WTRU IBR are described herein.

Herein, the terms prediction and estimation may be used interchangeably. Herein, the terms candidate cell, neighbor cell, and target cell may be used interchangeably. Herein, the terms source cell, current cell, and serving cell may be used interchangeably.

Artificial intelligence (AI) may be broadly defined as the behavior exhibited by machines. Such behavior may, for example, mimic cognitive functions to sense, reason, adapt and act. Machine learning may refer to type of algorithms that solve a problem based on learning through experience (‘data’), without explicitly being programmed (‘configuring set of rules’). Machine learning (ML) may be considered as a subset of AI. Different machine learning paradigms may be envisioned based on the nature of data or feedback available to the learning algorithm. For example, a supervised learning approach may involve learning a function that maps input to an output based on labeled training example, wherein each training example may be a pair including input and the corresponding output. For example, an unsupervised learning approach may involve detecting patterns in the data with no pre-existing labels. For example, reinforcement learning approach may involve performing sequence of actions in an environment to maximize the cumulative reward. It may be possible to apply machine learning algorithms using a combination or interpolation of the above-mentioned approaches. For example, semi-supervised learning approach may use a combination of a small amount of labeled data with a large amount of unlabeled data during training. In this regard, semi-supervised learning may fall between unsupervised learning (e.g., with no labeled training data) and supervised learning (e.g., with labeled training data).

Deep learning may refer to class of machine learning algorithms that employ artificial neural networks (specifically DNNs) which were loosely inspired from biological systems. The Deep Neural Networks (DNNs) may be a special class of machine learning models inspired by human brain wherein the input is linearly transformed and pass-through non-linear activation function multiple times. DNNs typically may include of multiple layers where each layer includes of linear transformation and a given non-linear activation functions. The DNNs may be trained using the training data via back-propagation algorithm. Recently, DNNs have shown state-of-the-art performance in a variety of domains, (e.g., speech, vision, natural language etc.) and for various machine learning settings supervised, un-supervised, and semi-supervised. The term AIML (artificial intelligence/machine learning) based methods/processing may refer to realization of behaviors and/or conformance to requirements by learning based on data, without explicit configuration of sequence of steps of actions. Such methods may enable learning complex behaviors which might be difficult to specify and/or implement when using legacy methods.

As described herein, an AIML model may be referred to an implementation of an AIML based method which is made up of model parameters and the model structure. For example, a DNN-based AIML model may include of the model parameters (e.g., weights and biases) and the model structure (e.g., the types and sizes of each layer of the deep neural network such as dense layers, convolutional layers)

A WTRU may transmit or receive a physical channel or reference signal according to at least one spatial domain filter. The term “beam” may be used to refer to a spatial domain filter. The WTRU may transmit a physical channel or signal using the same spatial domain filter as the spatial domain filter used for receiving an RS (such as CSI-RS) or a synchronization signal (SS) block. The WTRU transmission may be referred to as “target”, and the received reference signal (RS) or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by radio resource control (RRC) or signaled by MAC control element (CE) or downlink control information (DCI). For example, a WTRU may implicitly transmit physical uplink shared channel (PUSCH) and Demodulation Reference Signal (DM-RS) of PUSCH according to the same spatial domain filter as a sounding reference signal (SRS) indicated by an SRS resource indicator (SRI) indicated in DCI or configured by RRC. In another example, a spatial relation may be configured by RRC for a SRS source indicator (SRI) or signaled by MAC CE for a physical uplink control channel (PUCCH). Such spatial relation may also be referred to as a “beam indication”.

The WTRU may receive a first (e.g., target) downlink channel or signal according to the same spatial domain filter or spatial reception parameter as a second (e.g., reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS or SS block and a DM-RS by an index to a set of TCI states configured by RRC and/or signaled by MAC CE. Such indication may also be referred to as a “beam indication”.

Quasi co-location (QCL) assumptions and configurations are described herein. A WTRU may receive transmit configuration indication (TCI) related configuration(s). For example, the configurations may comprise a plurality of TCI-states (e.g., an RRC-configured pool of TCI-states (e.g., as unified TCI framework), ‘TCI-State’ IE, ‘TCI-UL-State’ IE, ‘spatialRelationInfo’ IE, etc.). A TCI-state of the plurality of TCI-states may be associated (e.g., comprised) with at least one of QCL-info #1, QCL-info #2, additionalPCI, pathloss RS (PLRS)-ID, UL-PC, Timing Advance Group (TAG)-ID, where QCL-info #1 (or QCL-info #2) may comprise a cell-ID (e.g., serving-cell index), a BWP-ID, a RS (e.g., CSI-RS, SSB-index), and/or a QCL-type which may be one of typeA, typeB, typeC, and/or typeD. In an example, the PLRS-ID may be for pathloss estimation for determining a UL transmission power when a UL transmission is based on a TCI-state that is associated with the PLRS-ID. In an example, the UL-PC (e.g., UL-PC parameter set, which may comprise at least one of P0, alpha, close-loop (CL)-index, power offset, etc.) may be for determining an uplink power for an UL transmission associated with the TCI-state. In an example, the additionalPCI may be a physical cell-ID (PCID) of a neighboring (or surrounding) cell that the RS (e.g., RS may be associated with the TCI-state), for example, SSB-index (or CSI-RS) may be transmitted from, for example, as an inter-cell beam (or RS) reference. In an example, the WTRU may apply a timing advance value (e.g., based on received timing advance command (TAC) (s)) in association with the TAG-ID (e.g., of multiple TAG-IDs being configured) to a scheduled UL transmission.

In an example, typeA may represent {Doppler shift, Doppler spread, average delay, delay spread}, typeB may represent {Doppler shift, Doppler spread}, typeC may represent {Doppler shift, average delay}, and/or typeD may represent {Spatial Rx parameter}. When a WTRU receives an indication or configuration of a TCI-state (e.g., applicable for a physical channel or signal) at least comprising a QCL-type (e.g., by typeA, typeB, typeC, or typeD) and an RS (e.g., an RS associated with the QCL-type), the WTRU may determine (e.g., derive) at least one parameter for transmission and/or reception, representing wireless channel characteristics (e.g., at least one of Doppler shift, Doppler spread, average delay, delay spread, and/or Spatial Rx parameter) based on the indicated QCL-type, and/or apply the at least one parameter for transmission or reception of the physical channel or signal.

A unified TCI (e.g., a common TCI, a common beam, and/or a common RS) may refer to a beam/RS to be (e.g., simultaneously) used for multiple physical channels or signals. The term “TCI” may at least comprise a TCI state that includes at least one source RS to provide a reference (e.g., WTRU assumption) for determining QCL and/or spatial filter.

In an example, a WTRU may receive (e.g., from a gNB) an indication of a first unified TCI to be used or applied for both a downlink control channel (PDCCH) and a downlink shared channel (PDSCH) (e.g., and a downlink RS). The source reference signal(s) in the first unified TCI may provide common QCL information at least for WTRU-dedicated reception on the PDSCH and all, some or a subset of control CORESETs in a CC. In an example, a WTRU may receive (e.g., from a gNB) an indication of a second unified TCI to be used or applied for both an uplink control channel (PUCCH) and an uplink shared channel (PUSCH) (e.g., and an uplink RS). The source reference signal(s) in the second unified TCI may provide a reference for determining common uplink (UL) transmission (TX) spatial filter(s) at least for dynamic-grant or configured-grant based PUSCH and all or some subset of dedicated PUCCH resources in a CC.

The WTRU may be configured with a first mode for unified TCI (e.g., SeparateDLULTCI mode, a parameter of ‘unifiedTCI-StateType’ set to ‘separate’) where an indicated unified TCI (e.g., the first unified TCI or the second unified TCI) may be applicable for either downlink (e.g., based on the first unified TCI) or uplink (e.g., based on the second unified TCI). In an example, a WTRU may receive (e.g., from a base station (BS), a gNB, and/or a TRP) an indication of a second unified TCI to be used or applied commonly for a PDCCH, a PDSCH, a PUCCH, and a PUSCH (e.g., and a DL RS and/or a UL RS).

The WTRU may be configured with a second mode for unified TCI (e.g., JointTCI mode, a parameter of ‘unifiedTCI-StateType’ set to ‘joint’) where an indicated unified TCI (e.g., the third unified TCI) may be applicable for both downlink and uplink (e.g., based on the third unified TCI). The WTRU may determine a TCI state applicable to a transmission or reception by first determining a Unified TCI state instance (e.g., TCI-state group, a group of TCI-states, and/or a set of activated TCI-states) applicable to this transmission or reception, and/or then determining a TCI state corresponding to the Unified TCI state instance. A transmission may include of at least PUCCH, PUSCH, sounding reference signal (SRS). A reception may include of at least PDCCH, PDSCH, channel state information reference signal (CSI-RS). A Unified TCI state instance may also be referred to TCI state group, TCI state process, unified TCI pool, a group of TCI states, a set of time-domain instances/stamps/slots/symbols, and/or a set of frequency-domain instances/RBs/subbands. A Unified TCI state instance may be equivalent or identified to a Coreset Pool identity (e.g., CORESETPoolIndex, and/or a transmission reception point (TRP) indicator).

Hereafter, unified TCI may be interchangeably used with one or more of unified TCI-states, unified TCI instance, TCI, and TCI-state, but still consistent with contents described herein. A WTRU may be configured with a plurality of transmission configuration indicator (TCI) states. For example, TCI may be unified TCI (UTCI) states, each applicable for multiple channel(s) or signal(s). The multiple channel(s) or signal(s) may be configured to the WTRU (or pre-determined or defined), for example in a form of a list, by a higher-layer signaling (e.g., RRC and/or MAC-CE) which may include one or more CORESETs, one or more PDCCH candidates, one or more search spaces, one or more PDSCHs (e.g., PDSCH occasions/configurations/instances), one or more RSs (e.g., CSI-RSs, DMRSs, SSB indexes, PRSs, PTRSs, and/or SRSs), one or more PUSCHs (e.g., PUSCH occasions/configurations/instances), one or more PUCCH resources (e.g., PUCCH resource sets/groups), and/or one or more PRACH occasions/resources/RSs.

The plurality of TCI states may be configured via an RRC signaling (e.g., and/or via a MAC-CE signaling, indication or activation). The WTRU may receive, for example, via the MAC-CE or a separate signaling, an information content comprising mapping between one or more codepoints of a DCI field (e.g., TCI field, and/or TCI selection field) and at least one TCI state of the plurality of TCI states. The WTRU may receive a DCI comprising the DCI field. The WTRU may be indicated with one or more TCI states, of the plurality of TCI states, mapped to a codepoint of the one or more codepoints of the DCI field, where each of the one or more TCI states is applicable after a time duration determined based on a beam application time (BAT) parameter.

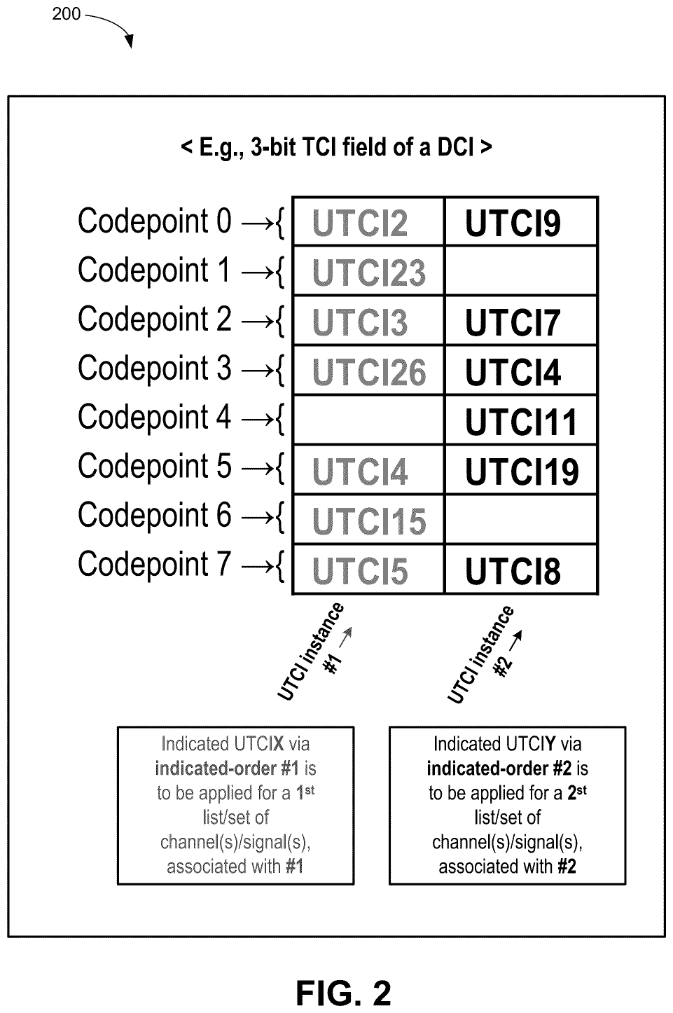

FIG. 2 shows an example of the DCI field (e.g., TCI field) of a DCI for unified TCI-state indications. The WTRU may receive the mapping between a codepoint (of the DCI field) and one or more TCI states, illustrated in 200, for example, via a MAC-CE signaling. For example, Codepoint 2 may be mapped to {UTCI3, UTCI7}, where the WTRU may apply at least one of {UTCI3, UTCI7} to the multiple channel(s)/signal(s), for example, based on a list of the multiple channel(s)/signal(s) configurable by a higher-layer signaling from a gNB. In an example, the list of the multiple channel(s)/signal(s) may be given per unified transmission configuration indicator (UTCI) instance (e.g., TCI-state group, a group of TCI-states, a set of activated TCI-states), where the UTCI instance may correspond to each column of the mapping table, illustrated in the figure, between a codepoint and the one or more TCI states.

A TRP (e.g., transmission and reception point) may be interchangeably used with one or more of TP (transmission point), RP (reception point), RRH (radio remote head), DA (distributed antenna), BS (base station), a sector (of a BS), and/or a cell (e.g., a geographical cell area served by a BS). Multi-TRP may be interchangeably used with one or more of MTRP, M-TRP, and multiple TRPs, but still consistent with contents described herein.

A WTRU may be configured with (or may receive configuration of) one or more TRPs to which the WTRU may transmit and/or from which the WTRU may receive. The WTRU may be configured with one or more TRPs for one or more cells. A cell may be a serving cell, and/or a secondary cell.

A WTRU may be configured with at least one RS for the purpose of channel measurement. This RS may be denoted as a Channel Measurement Resource (CMR) and may comprise a CSI-RS, SSB, or other downlink RS transmitted from the TRP to a WTRU. A codebook mode reporting (CMR) may be configured or associated with a TCI state. A WTRU may be configured with a CMR group where CMRs transmitted from the same TRP may be configured. Each group may be identified by a CMR group index (e.g., group 1). A WTRU may be configured with one CMR group per TRP, and the WTRU may receive a linkage between one CMR group index and another CMR group index, or between one RS index from one CMR group and another RS index from another group.

A WTRU may be configured with (or receive configuration of) one or more pathloss (PL) reference groups (e.g., sets) and/or one or more SRS groups, SRS resource indicator (SRI) or SRS resource sets. A PL reference group may correspond to or may be associated with a TRP. A PL reference group may include, identify, correspond to, or be associated with one or more TCI states, SRS resource indicators (SRIs), reference signal sets (e.g., CSI-RS set, SRI sets), CORESET index, and/or reference signals (e.g., CSI-RS, SSB).

A WTRU may receive a configuration (e.g., any configuration described herein). The configuration may be received from a gNB or TRP. For example, the WTRU may receive configuration of one or more TRPs, one or more PL reference groups, and/or one or more SRI sets. A WTRU may implicitly determine an association between a RS set/group and a TRP. For example, if the WTRU is configured with two sounding reference signal (SRS) resource sets, then the WTRU may determine to transmit to TRP1 with SRS in the first resource set, and to TRP2 with SRS in the second resource set. The configuration may be via RRC signaling.

In the examples and embodiments described herein, TRP, PL reference group, SRI group, and SRI set may be used interchangeably. The terms set and group may be used interchangeably herein.

The WTRU may report one or more beam quality metrics (e.g., L1-RSRP). For example, each of the one or more quality metrics include a corresponding beam or a RS-ID. A WTRU may report a subset of channel state information (CSI) components, where CSI components may correspond to at least a CSI-RS resource indicator (CRI), an SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and/or other channel state information such as at least rank indicator (RI), channel quality indicator (CQI), precoding matrix indicator (PMI), Layer Index (LI), and/or the like.

A property of a grant or assignment may include one or more of: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index, a periodicity of a configured grant or assignment; a channel access priority class (CAPC); and/or any parameter provided in a DCI, by MAC or by RRC for the scheduling the grant or assignment.

An indication by downlink control information (DCI) may include an explicit indication by a DCI field or by radio network temporary identifier (RNTI) used to mask cyclic redundancy check (CRC) of the PDCCH, and/or an implicit indication by a property. An implicit indication by a property may be DCI format, DCI size, Coreset or search space, Aggregation Level, and/or first resource element of the received DCI (e.g., index of first Control Channel Element), where the mapping between the property and the value may be signaled by RRC or MAC.

As described herein, a signal may be interchangeably used with sounding reference signal (SRS), channel state information-reference signal (CSI-RS), demodulation reference signal (DM-RS), phase tracking reference signal (PT-RS), or synchronization signal block (SSB). A channel may be interchangeably used with physical downlink control channel (PDCCH), physical downlink shared channel (PDSCH), physical uplink control channel (PUCCH), physical uplink shared channel (PUSCH), or physical random access channel (PRACH). Downlink reception may be used interchangeably with Rx occasion, PDCCH, PDSCH, or SSB reception. Uplink transmission may be used interchangeably with Tx occasion, PUCCH, PUSCH, PRACH, or SRS transmission. RS may be interchangeably used with one or more of RS resource, RS resource set, RS port and RS port group. RS may be interchangeably used with one or more of SSB, CSI-RS, SRS and DM-RS. Time instance may be interchangeably used with slot, symbol, subframe. UTCI may be interchangeably used with TCI, UTCI state, TCI state.

WTRU-initiated beam reporting (WTRU IBR) is described herein. A WTRU may receive configuration for a WTRU-initiated beam measurement and reporting procedure based on at least one event being defined or configured to trigger the WTRU IBR. For example, the at least one event may comprise an event for aiding BS's better decision to update a current beam (e.g., TCI-state, indicated TCI-state) where the event may be triggered when a quality of at least one new beam, such as L1-RSRP, becomes a threshold value better than the current beam. Here, the current beam may correspond to a beam (e.g., RS, TCI-state, indicated TCI-state) that is currently being used for DL and/or UL communication at least with the BS (e.g., serving BS, gNB, TRP). In an example, an RS for the current beam may be implicitly derived from a QCL-RS (e.g., source-QCL RS configured in a TCI-state) of an indicated TCI-state. The WTRU may receive a configuration or an indication to apply one or more of WTRU-IBR mode A, or WTRU-IBR mode B.

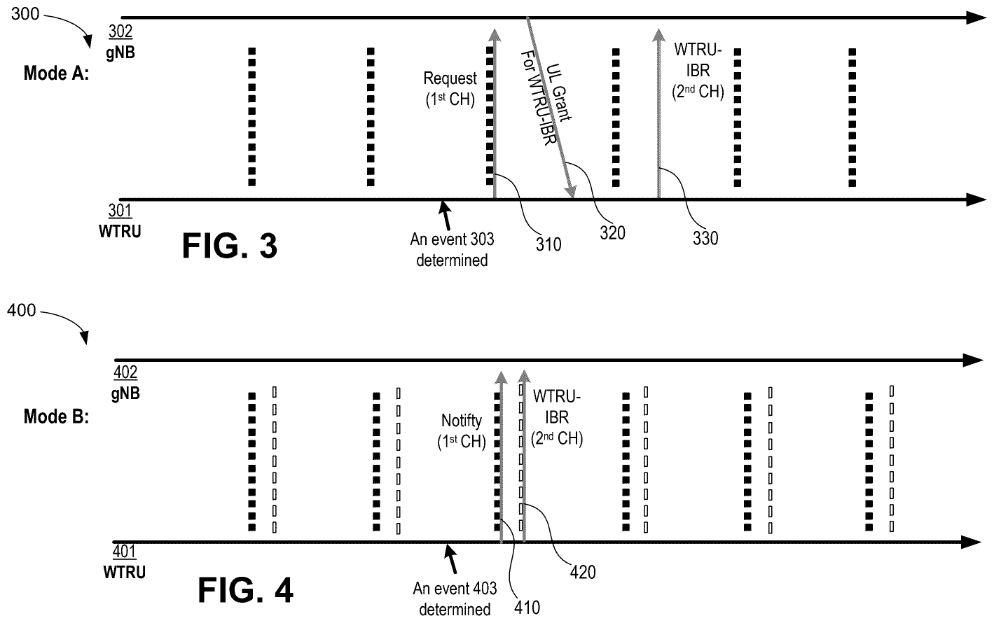

FIG. 3 is a system diagrams 300 illustrating WTRU-initiated beam reporting mode A. FIG. 4 is a system diagram 400 illustrating WTRU-initiated beam reporting mode B. WTRU-IBR Mode A may be based on dynamically scheduled UL resource for WTRU-IBR, for example, carrying uplink control information (UCI), where examples and illustrations are shown based on FIG. 3. In an example as shown in FIG. 3, at 310, the WTRU 301 may transmit a first PUCCH (e.g., one-bit, multi-bit) to request a resource for a second UL channel to carry beam report (WTRU-IBR), when the WTRU 301 determines that a condition for triggering the event 303 for WTRU-IBR is met. When the BS or gNB 302 successfully received the first PUCCH, the BS or gNB 302 may transmit a PDCCH (e.g., a DCI) assigning a proper UL resource on which the WTRU may transmit the WTRU-IBR. At 320, the WTRU may detect, for example, a PDCCH (e.g., the PDCCH, the DCI, a DCI format) that indicate a resource for a second UL channel to carry beam report. At 330, the WTRU may transmit the beam report (e.g., WTRU-IBR) in the second UL channel (e.g., scheduled, and/or granted by the DCI in the 320).

WTRU-IBR Mode B, for example, may be based on pre-configured resource(s) of the second channel for WTRU-IBR, where examples and illustrations are shown based on FIG. 4. In an example 400, at 410, the WTRU 401 may transmit a first PUCCH (e.g., one-bit, multi-bit) to notify (e.g., to the BS or gNB 402) that a UL transmission via at least one transmission occasion based on the second channel (e.g., being pre-configured) to carry beam report (WTRU-IBR) will occur (e.g., be performed by the WTRU 401). An event 403 may be determined at 400. At 420, the WTRU 401 may transmit the beam report (e.g., WTRU-IBR) by using at least one transmission occasion based on the second UL channel (e.g., that is pre-configured).

WTRU-IBR procedure associated with one or more events and related WTRU behaviors on measurements and reporting contents are described herein. The WTRU may receive configuration of each applicable event definition. For example, Event-1 may be for checking if a current beam quality becomes worse than a threshold. Event-2 may be for checking if a current beam quality becomes a threshold value worse than a new beam quality. Event-7 may be for checking if a M-th best activated beam quality becomes a threshold value worse than a new beam quality, for example, where a value of M can be configured.

The WTRU may receive configuration associating a UL indication resource to a combination of one or more events. For example, the UL indication resource may be based on multiple PUCCH resources (e.g., each with a PUCCH resource ID) to be used for delivering a WTRU-initiated beam reporting (WTRU-IBR) request (or notification), where a PUCCH resource (e.g., of the multiple PUCCH resource) may be associated with one or more Event-ID(s) and one common scheduling request (SR)-ID.

In an example, one SR-ID (e.g., SR-ID #7) may be dedicated for the WTRU-IBR procedure, and be associated with multiple PUCCH resources. For example, PUCCH-resource ID #1 may be associated with Event-1. PUCCH-resource ID #2 may be associated with Event-2. PUCCH-resource ID #3 may be associated with Event-7. PUCCH-resource ID #4 may be associated with both Event-1 and Event-2 when occurred simultaneously. PUCCH-resource ID #5 may be associated with both Event-2 and Event-7 when occurred simultaneously. PUCCH-resource ID #6 may be associated with Event-1, Event-2, and Event-7 when occurred simultaneously. The WTRU may receive configuration information comprising event-based uplink (UL) resource selection. Each UL indication resource of a plurality of UL indication resources in the configuration information may be configured for indicating a corresponding one or more applicable events detectable at the WTRU.

The WTRU may determine that a condition for a first one or more events (e.g., the Event-2, and/or the Event-7) is met based on the configured applicable event definition. The WTRU may determine a UL indication resource, for example, a PUCCH resource ID (e.g., ID #2, or ID #3, or ID #5), based on the detected first one or more events and the configuration. The WTRU may detect a triggering condition for at least one of the one or more applicable events based on a configured applicable event definition. The WTRU may determine, in response to the triggering condition being detected, the corresponding UL indication resource based on the one or more applicable events in the configuration information.

The WTRU may transmit the selected UL indication, based on the UL indication resource, for example, delivering the WTRU-IBR request. The WTRU may receive a UL grant (e.g., DCI) for transmitting WTRU-IBR contents. The WTRU may transmit, based on the received UL grant, the WTRU-IBR contents determined based on the first one or more events. The WTRU may transmit, to a gNB, on the UL indication resource to indicate the detection of the triggering condition for the at least one of the one or more applicable events. The WTRU may receive, in response to the transmission on the UL indication resource, a dedicated UL grant configured to transmit WTRU initiated beam reporting contents. The WTRU may transmit, based on the received dedicated UL grant, the WTRU initiated beam reporting contents. The WTRU may transmit, in response to the transmission on the UL indication resource, WTRU initiated beam reporting contents. The transmission on the UL indication resource may include one bit or two bits. In an example, the transmission on the UL indication resource may be less than a threshold number of bits, such as one bit or two bits.

Configuration for multi-event-based WTRU-IBR procedures may be described herein. For determination of at least one new beam, a quality metric, for example, RSRP (e.g., Layer-3 filtered RSRP), Layer-1 (L1)-RSRP, SINR, L1-SINR, RSRQ, and/or L1-RSRQ, may be used, where for each at least one threshold is configured for the assessment of the measured beam. A beam may be represented by a reference signal (RS). Hence, beam and RS may be used interchangeably.

In anticipation of an update of a current beam (e.g., a current reference beam, an activated beam, a M-th best-quality (or worst-quality) activated beam, a (reference) beam to be compared with the at least one new beam), various events may be defined (e.g., various events may be explicitly configured to a WTRU, pre-configured for the WTRU-IBR procedure, or (implicitly) identified based on conditions or rules). In one example, a reporting event may be defined based on a determination that a current beam has degraded by a configured threshold than a new beam from a set of candidate new beams. The set of candidate new beams may be defined, configured, or indicated in several ways. A WTRU may receive (explicit) configuration, for example, by RRC, of the set of candidate new beams. A WTRU may receive an RRC configured initial set of beams, from which a subset may be dynamically indicated (e.g., via a MAC-CE) as the set of candidate new beams.

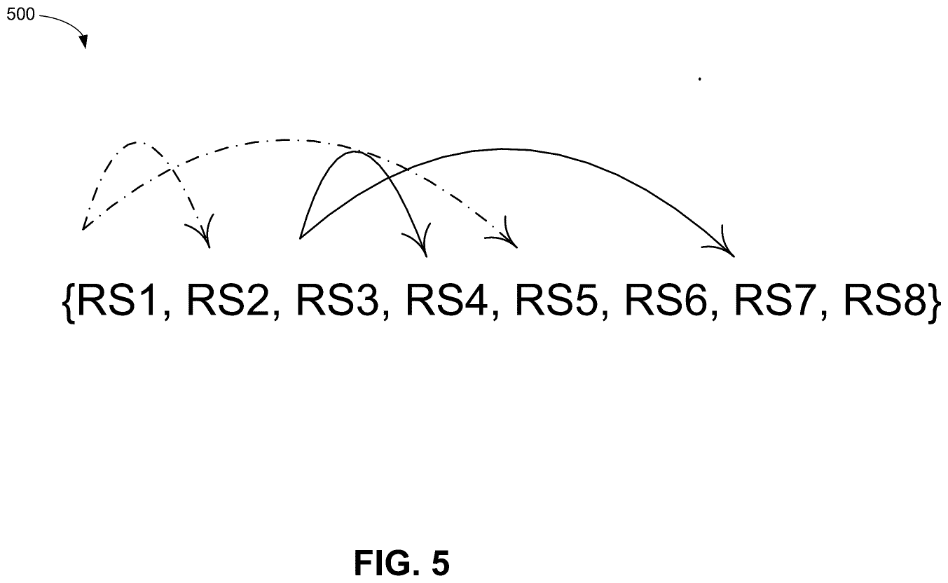

FIG. 5 illustrates an association 500 of a current beam and a set of candidate new beam. A WTRU may be semi statically or dynamically configured with an initial set of beams, wherein each beam is associated with a subset of the beams from the configured initial set. As such, the associated subset of the beams may be considered as the set of candidate new beams. For example, as shown in FIG. 5, for a current beam, represented by RS1, the set of candidate beams may contain beams represented by {RS2, RS5}, while for a current beam represented by RS3, the set of candidate beams comprises beams represented by {RS4, RS7}. Therefore, a WTRU may update the candidate set of beams according to the association between the detected new beam and other configured beam.

When a new beam is detected by a WTRU, the WTRU may send a request for update of the set of candidate new beams. The WTRU may continue with the configured set of candidate new beams, unless the WTRU receives or determines a new configuration. In an update request, a WTRU may also report the beams that are below a configured threshold to be dropped from the set of candidate new beams. The indicated weak beams may be dropped from the set of candidate new beams, when the WTRU receives a drop confirmation from the gNB.

A WTRU may be configured, indicated, or fixed with an integer value N≥1, where N represents the maximum number of candidate new beams that can be reported by a WTRU. Once a WTRU determines existence of at least one candidate new beam that is better than the current beam by a configured threshold, the WTRU may report the identified candidate new beam to the gNB. Further, the WTRU may report up to N−1 other candidate beams that meet a quality metric. For example, the quality metric may be better than a current beam by a configure threshold, or be based on a second rule being configured or indicated on condition that at least one of the N−1 other candidate beams meet a second quality metric based on a second configured or indicated threshold. In selection of N−1 other beams, the WTRU may do one or more actions.

A WTRU may compare the quality of the N−1 other candidate new beams against a second threshold. The second threshold may be referenced from the first threshold for determination of a candidate new beam or referenced from the measured quality of the new beam. Hence, the WTRU may report K of the identified N−1 beams and drop the remaining N-K−1 beams. Or the WTRU may report the K beams as well as the remaining N-K−1 beams, for example, with an indicator that provides information on the value of K and/or the selected K beams.

The WTRU may simultaneously monitor measurements defined (or configured, indicated) for more than one type of events for reporting (e.g., as a part of a multi-event-based WTRU-IBR procedure). For example, a WTRU may concurrently monitor one or more types of events (e.g., being configured, identified, defined, indicated).

Type-1 event (Event-1) may be defined as the measured quality metric of a current beam becomes worse than a configured threshold. Type-2 event (Event-2) may be defined as the measured quality metric for the current beam becomes a threshold value worse than a candidate new beam quality. For example (e.g., in other words), a candidate new beam quality becomes a threshold value better than a measured quality metric of a current beam. Type-3 event (Event-3) may be defined as a candidate new beam quality becomes better than a configured threshold. Type-4 event (Event-4) may be defined as the measured quality metric for a current beam becomes worse than a first configured threshold, and a candidate new beam quality becomes better than a second configured threshold. Type-5 event (Event-5) may be defined as a value (e.g., an absolute value) of the difference between the quality of a current beam and the quality of at least one candidate new beam is lower than a configured threshold. Type-6 event (Event-6) may be defined as the measured quality metric for the current beam becomes a threshold value worse than the quality (e.g., qualities, one of quality metrices, and/or any of quality metrics) of at least C (e.g., C>1) candidate new beams. Type-7 event (Event-7) may be defined as the measured quality metric for the M-th best (e.g., or worst) activated beam quality becomes a threshold value worse than a candidate new beam quality, where M may be a configured non-zero integer value. Type-8 event (Event-8) may be defined as the measured quality metric for at least one candidate new beam(s) becomes a threshold value better than a (separately) configured reference RS (e.g., SSB, CSI-RS).

Hereafter, the Type-1 event (Event-1), the Type-2 event (Event-2), and/or the Type-7 event (Event-7) may be considered (selectively as examples) to be applied for a multi-event-based WTRU-IBR procedure. However, the proposed embodiments and processes (described herein) may equally (e.g., or equivalently or extendedly) be employed based on a set (e.g., any set, a combination, and/or any combination) of Event types, illustrated above, and/or other possible (different) types of Events.

For reporting of an event (and/or corresponding report contents), a WTRU may receive one or more of resource configurations for reporting, for example, PUCCH or PUSCH resources, where a PUCCH resource of the PUCCH resources may be a scheduling request (SR) resource (e.g., as the UL indication resource) associated with an SR-ID. In an example, the SR resource (associated with a first SR-ID) may be dedicated for the WTRU-IBR procedure, while the WTRU may be configured with other SR-ID(s) (not including the first SR-ID) to be used for general (e.g., conventional) buffer-status report (BSR) to inform (e.g., to a BS) that the WTRU has a buffered data for a UL (e.g., data) transmission and/or requests a UL grant for a PUSCH transmission.

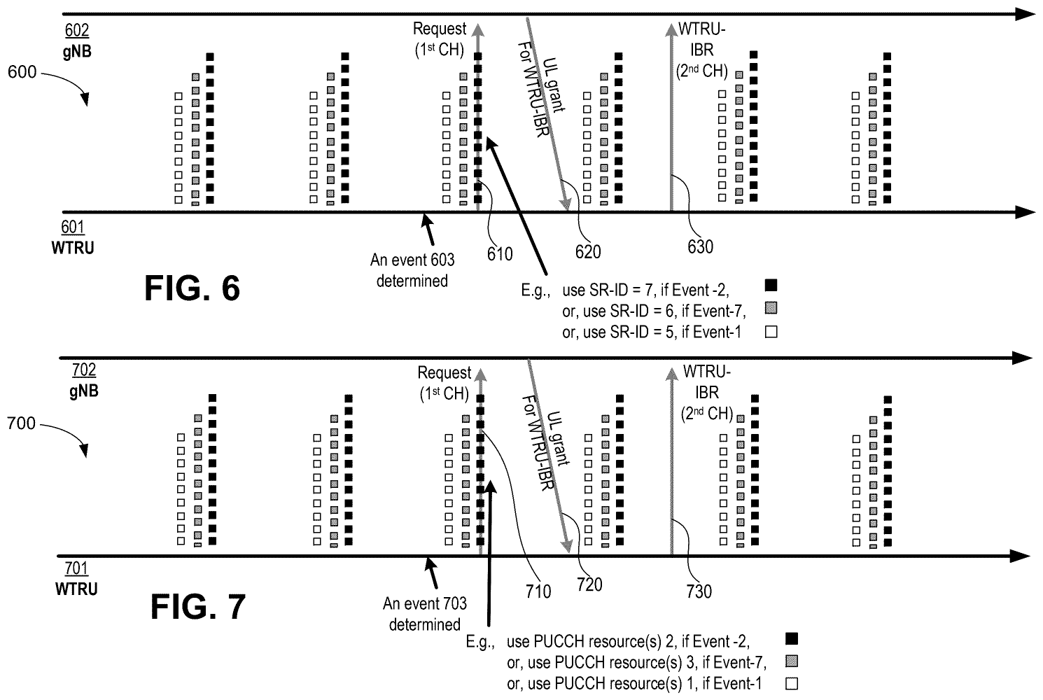

FIG. 6 illustrates an example 600 of an event 603 associated with a dedicated UL resource ID (e.g., SR-ID). A WTRU 601 may receive separate reporting configuration for each report, and for example, a WTRU 601 may be configured, with three SR resources, where each SR resource (e.g., being associated with each corresponding PUCCH resource) may be associated with a different event. As such, a WTRU 601 may use selection of the SR resource (e.g., SR-ID=5, 6, or 7) as an indication of the occurred event (e.g., as the UL indication resource), as illustrated in FIG. 6. An event 603 may be determined at 600. At 610, a request may be sent from the WTRU 601 to gNB 602 via a first channel. At 620, a UL grant for WTRU-IBR may be sent from the gNB 602 to the WTRU 601. At 630, the WTRU 601 may send a WTRU-IBR to the gNB 602 via a second channel.

In an example, the WTRU 601 may receive a configuration or an indication that an SR-ID (e.g., ‘SchedulingRequest-ID’, or a new UCI-type ID) for the first UL channel (e.g., the first step in Mode A or Mode B) of a WTRU-IBR procedure is associated (e.g., flagged, configured, indicated) with an event (e.g., with Event-ID, Event-1, 2, or 7). On condition that the WTRU 601 does not receive the configuration or the indication, the WTRU may determine that the first UL channel transmission (e.g., as for the first step) may be associated with a default Event (e.g., Event-2 as the default Event, or Event-1 as the default Event).

FIG. 7 illustrates an example 700 of an event 703 associated with a dedicated PUCCH resource ID. A WTRU 701 may receive separate reporting configuration for each report, and for example, a WTRU 701 may be configured, with three PUCCH resources (e.g., all or some of the PUCCH resources being associated with a common SR-ID, e.g., SR-ID=7 for a WTRU-IBR procedure), where each PUCCH resource may be associated with a different event (e.g., although each PUCCH resource may be associated with a same or common SR-ID). As such, a WTRU may use selection of the PUCCH resource as an indication of the occurred event (e.g., as the UL indication resource), as illustrated in FIG. 7. An event 703 may be determined at 700. At 710, a request may be sent from the WTRU 701 to gNB 702 via a first channel. At 720, a UL grant for WTRU-IBR may be sent from the gNB 702 to the WTRU 701. At 730, the WTRU 701 may send a WTRU-IBR to the gNB 702 via a second channel.

In an example, one SR-ID (e.g., SR-ID=7, out of 8 configured SR-IDs) may be (e.g., dedicatedly) associated with the WTRU-IBR procedure, where the one SR-ID may be (further) associated with more than one PUCCH resources (e.g., PUCCH resource 1, 2, or 3, for each representing (corresponding) Event). In another example, a PUCCH format may be configured (or indicated to use) for the WTRU-IBR procedure, where the WTRU may transmit a PUCCH (e.g., as the first UL channel, the first PUCCH of the WTRU-IBR) based on selecting at least one parameter associated with the PUCCH transmission to deliver (e.g., flag) which event is associated with the PUCCH transmission, for example, based on a ON/OFF-keying type of signaling for the PUCCH transmission, and/or based on a scrambling sequence (or sequence initialization parameter) based differentiation of the triggered event.

In case of simultaneous occurrence of multiple events, a WTRU may report each event based on a priority. For example, the WTRU may first report Type-1 event (Event-1), then Type-7 (Event-7) and then Type-2 (Event-2). The definition of the priority may be fixed, configured or determined based on other operational aspect, for example, mobility state, traffic type, channel condition, and/or multiplexing rule with other (on-going or occurred) reporting (e.g., other CSI/beam reporting).

The WTRU may receive configuration on additional PUCCH resource(s) for use when a particular combination of multiple events occurred concurrently. For example, a PUCCH resource 11 may be configured to be used when both Event-1 and Event-2 occurred, and/or a PUCCH resource 15 may be configured to be used when both Event-2 and Event-7 occurred, and/or a PUCCH resource 22 may be configured to be used when the Event-1, Event-2, and Event-7 concurrently occurred. In an example, in case of simultaneous occurrence of both Event-1 and Event-2, the WTRU may transmit the first PUCCH by using the PUCCH resource 11. In case of simultaneous occurrence of both Event-2 and Event-7, the WTRU may transmit the first PUCCH by using the PUCCH resource 15. In one example, in case of occurrence of multiple events, each reporting resource, for example, PUCCH resource, may contain the information related to its corresponding event. For example, PUCCH resource 1 for Event Type-1, PUCCH resource 2 for Event Type-2, and/or PUCCH resource 3 for Event Type-7.

In case of occurrence of multiple events, each reporting resource, for example, PUCCH resource, may contain the information related to each reporting resource's corresponding event, as well as an indication of occurrence of other events. For example, in case of occurrence of Event Type-1 and one or more other events, the reporting may also carry a side-indication, for example, a single (or more than one) bit. A WTRU may use the side-indication to indicate more than one event has been detected, and/or to indicate that the current reporting may follow with one or more (e.g., additional) reports. For example, the WTRU may send more PUCCH (resources) after sending the first PUCCH (resource).

A WTRU may receive a smaller number of reporting configurations than the number of potential concurrent events to report. For example, a WTRU may be configured, with a single PUCCH resources, where each PUCCH resource may be associated with any type of event. When a WTRU detects more than one events, depending on the size of the reporting resource, a WTRU may follow a priority order to select one or more events for reporting.

In such case, the reporting content may also include a side-indication, (e.g., a single, or more than one bit), for example, to indicate that the WTRU has detected more events. However the corresponding WTRU-IBR contents generated by the detected more events were dropped from the report. The side indication may include an identity index (e.g., an ID, and/or an indicator) corresponding to the dropped event(s). A WTRU may use the side indication as a scheduling request for reporting of the dropped event(s).

Based on the determination on which first UL channel (e.g., based on selecting an SR-ID, based on selection a PUCCH resource, in response to the triggered event) is used for the first PUCCH transmission of the WTRU-IBR procedure, the WTRU may determine corresponding contents reported via the second UL channel (WTRU-IBR) based on the triggered event (e.g., event-ID). In an example, if Event-2 is triggered, the contents in WTRU-IBR may include beam quality metric(s) of new beam(s) that satisfies the condition for Event-2 (e.g., a threshold better than that of the current beam). In an example, if Event-7 is triggered, the contents in WTRU-IBR may include beam quality metric(s) of new beam(s) that satisfies the condition for Event-7 (e.g., a threshold better than that of the M-th best activated TCI-state). In an example, if both Event-2 and Event-7 are triggered, the contents in WTRU-IBR may include beam quality metric(s) of new beam(s) that satisfies the condition for Event-2 and/or Event-7, for example, which may require bigger payload to carry WTRU-IBR contents generated by both events. And so forth.

This may provide benefits in that the BS may properly assign the payload (and other parameters) for the second UL channel (to be fit and proper for the triggered Event), by sending the PDCCH (e.g., the DCI) in Step-2 of the WTRU-IBR procedure, because a different event may require a different payload amount for the corresponding WTRU-IBR.

The WTRU may be configured (e.g., may be allowed) to transmit more than one first UL channel, each corresponding to its associated event(s) as illustrated in FIGS. 6 and 7, that each is associated with the same second UL channel (e.g., many-to-one mapping between first and second UL channels for the WTRU-IBR procedure). The WTRU may transmit the more than one first UL channel (e.g., within a short (configured) time period that can be associated with one same second UL channel), that may be triggered due to more than one event occurred. Based on the transmitted more than one first UL channel, the WTRU may transmit contents for WTRU-IBR comprising aggregated report contents accommodating each of the triggered events. This may provide benefits in that the BS may properly assign the payload (and other parameters) for the second UL channel (to be fit for each of the triggered multiple events), for example, by the DCI in Step-2.

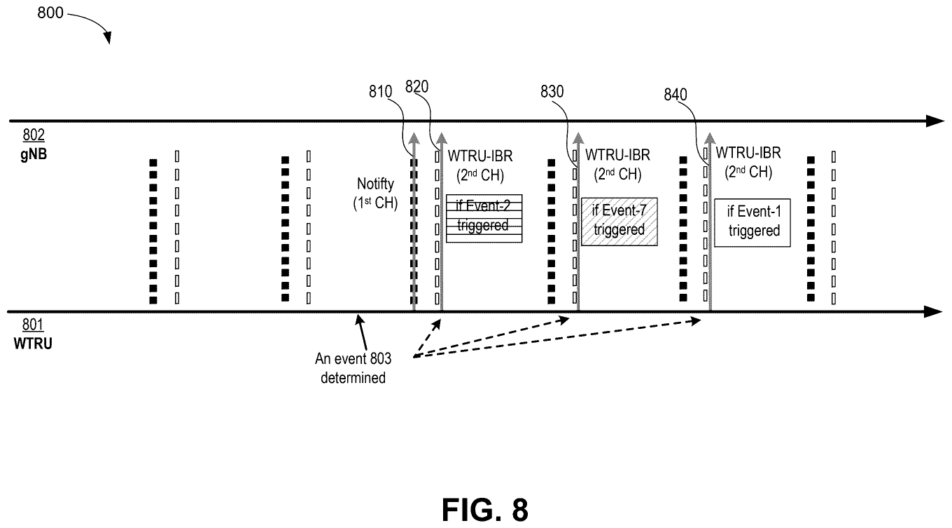

FIG. 8 is a system diagram 800 illustrating an example of a WTRU-initiated beam reporting procedure based on pre-configured UL resources. The WTRU may (e.g., be configured to) select a first available Tx occasion of the second UL channel (e.g., out of a plurality of Tx occasions being pre-configured, like in Mode B) based on at least one event occurring (e.g., or being triggered), like being illustrated in FIG. 8. The WTRU 801 may be configured (or indicated) with one common SR-ID or a common (e.g., new or dedicated) PUCCH resource for the first UL channel transmission of the WTRU-IBR procedure, for example, although multiple events are configured. The WTRU 801 may (e.g., be configured to) use a different time-domain (e.g., frequency-domain, spatial-domain, and/or power-domain) resource of the second UL channel transmission to differentiate which event(s) occurring. An event 803 may be determined at 800. At 810, the WTRU 801 may notify a gNB 802 via a first channel. At 820, if Event-2 is triggered, the WTRU 801 may send a WTRU-IBR to the gNB 802 via a second channel. At 830, if Event-7 is triggered, the WTRU 801 may send a WTRU-IBR to the gNB 802 via a second channel. At 840, if Event-1 is triggered, the WTRU 801 may send a WTRU-IBR to the gNB 802 via a second channel. For example, if Event-2 is triggered, the WTRU 801 may transmit on the first available Tx occasion for WTRU-IBR after transmitting the first UL channel. If Event-7 is triggered, the WTRU 801 may transmit on a second available Tx occasion (e.g., after the first available Tx occasion) for WTRU-IBR after transmitting the first UL channel. If Event-1 is triggered, the WTRU 801 may transmit on a third available Tx occasion (e.g., after the second available Tx occasion) for WTRU-IBR after transmitting the first UL channel. This may provide benefits because the BS may set up a prioritization across different events, for example, Event-2 may be set as the highest priority such that WTRU-IBR upon Event-2 may be transmitted in the earliest possible Tx occasion (e.g., the first available Tx occasion).

In an example, for each second channel transmission, the WTRU may transmit one (or more) information bit indicating that there will be a continued (e.g., followed) WTRU-IBR transmission in a next available Tx occasion, for example, where the information bit may be ‘0’ for no more WTRU-IBR, ‘01’ for one more Tx occasion followed, ‘10’ two more Tx occasions followed to be sent in the first Tx occasion as a part of WTRU-IBR contents. If the pre-configured Tx occasions for Event-2 has smaller periodicity that those for Event-7, the WTRU may be configured (e.g., allowed) to indicate (e.g., by using the information bit, when the first available Tx occasion is used for delivering Event-2 based WTRU-IBR contents) that the followed (e.g., or upcoming) Event-7 based WTRU-IBR contents will be reported by utilizing (e.g., reusing, or overriding) the pre-configured Tx occasions for Event-2, which may provide latency reduction in WTRU-IBR based on Event-7 occurred (e.g., by utilizing shorter periodicity of pre-configured resources assigned for Event-2).

In an example, regarding the spatial-domain resource partition across different events, upon transmitting the first UL channel, for example, triggered due to both Event-2 and Event-7, the WTRU may transmit WTRU-IBR on the first available Tx occasion via simultaneous multi-panel (and/or multi-beam) UL transmissions where each event-specific contents may be transmitted from each separated spatial-domain resource (e.g., different WTRU-panel wise, and/or different UL Tx beam wise).

In an example, a WTRU may determine the WTRU-IBR reporting contents, for example, when Event-2 is triggered, based on a pre-defined (or pre-configured) table, as shown in Table 1. This example shows a quality metric may be based on layer-1 (L1) RSRP for a beam (e.g., CRI and/or SSBRI), where a different quality metric (e.g., L1-SINR) may be applicable based on a configuration or indication, for example, from a BS. The WTRU may determine top-N beams to be reported, along with their corresponding quality metric (e.g., L1-RSRP). In an example, the CRI or SSBRI #1 may represent the highest beam quality out of the N beams being reporting, where a value of the quality of the CRI or SSBRI #1 is reported as “L1-RSRP #1” (e.g., 7 bits quantized) correspondingly. The WTRU may also report CRI or SSBRI #2˜#N, each with corresponding quality metric of “differential L1-RSRP #2˜#N” correspondingly, where each differential RSRP (e.g., 4 bits quantized) may be determined (e.g., calculated) based on the RSRP difference from the measured (e.g., highest) L1-RSRP corresponding to CRI/SSBRI #1. If the WTRU is configured to report the quality of the current beam, the WTRU may report (additionally) the quality value of the current beam, for example, without reporting the beam index of the current beam. For example, differential L1-RSRP #2˜#N (and current beam) may be determined based on the difference between measured L1-RSRP corresponding to the CRI/SSBRI #2˜#N (and current beam) and the measured L1-RSRP corresponding to CRI/SSBRI #1.

TABLE 1
Example of determination on WTRU-IBR
contents triggered based on an event

CRI or SSBRI #1
CRI or SSBRI #2
. . .
CRI or SSBRI #N
L1-RSRP #1
Differential L1-RSRP #2
. . .
Differential L1-RSRP #N
Differential L1-RSRP for current beam, if report mode that current beam
is always reported is enabled by RRC

When other event(s) (e.g., other than Event-2) is triggered for WTRU-IBR, the corresponding WTRU-IBR contents derivation procedure may be pre-configured or determined, for example, based on modifying and/or extending Table 1 to be applicable for each configured event.

In an example, upon Event-1 (e.g., when the measured quality metric of a current beam becomes worse than a configured threshold) being triggered, the WTRU may transmit the first UL channel (based on indicating the WTRU-IBR occurred by Event-1, for example, via a dedicated SR-ID for Event-1 and/or a dedicated PUCCH resource ID for Event-1) and not transmit the corresponding second UL channel for WTRU-IBR. In another example, upon Event-1 being triggered, the WTRU may transmit the first UL channel and also transmit the second UL channel delivering the measured quality metric of the current beam (although it is worse than a configured threshold). The benefits may be to deliver additional information on a quantitative difference between the threshold and the currently measured quality of the current beam, where the reported quantitative difference may be utilized at the BS on whether to update the current beam, whether to update the whole activated beam set, and/or whether to initiate a hand-over process or mobility management for the WTRU to be better served in the network. Delivering the measured quality metric in the WTRU-IBR may comprise reporting a “delta” value, for example, compared with the threshold. For example, the delta value may be a value representing “3 dB”, which may be interpreted as “3 dB below the threshold”. The WTRU may transmit (e.g., in addition to the current beam quality, L1-RSRP, and/or L1-SINR) one or more other candidate beams' quality metric(s), providing benefits in terms of “proactive” WTRU report to deliver useful candidate beam IDs and/or corresponding quality metrics, which may be based on WTRU's “prediction” based procedure (e.g., based on a pre-configured operation) to determine such candidate beam IDs. This may provide benefits in terms of “early pre-caution” purpose to prevent a beam failure procedure to be initiated.

In an example, when more than one event (e.g., both Event-2 and Event-7) occurred simultaneously, if the WTRU is configured to report up to N (e.g., N=4) candidate beams for WTRU-IBR, the WTRU may be configured to report at least Q (e.g., configurable Q=1, and/or Q-2) candidate new beams that are selected due to Event-7, out of the (maximum) N candidate beams to be chosen. The at least Q candidate new beams that are selected due to Event-7 may imply that the WTRU is configured to determine the at least Q new beams out of non-activated TCI-states (e.g., which are among configured TCI-states but not currently activated TCI-states).

In another example, when more than one event (e.g., both Event-2 and Event-7) occurred simultaneously, if the WTRU is configured to report up to N (e.g., N=4) candidate beams for WTRU-IBR, the WTRU may be configured to report at least R (e.g., configurable R=1, or R=2) candidate new beams, that are selected due to Event-2, out of the (maximum) N candidate beams to be chosen. The at least R candidate new beams that are selected due to Event-2 may imply that the WTRU is configured to determine the at least R new beams out of currently activated TCI-states (e.g., for aiding BS's better decision to change or update the current indicated TCI-state among the currently activated TCI-states).

Such restrictions based on Q and/or R may be configured or indicated simultaneously to the WTRU. For example, when Q=2 and R=1 are configured for such restriction, the WTRU may determine at least Q=2 new beams corresponding to the occurred Event-7, at least R=1 new beams corresponding to the occurred Event-2, and any remaining N-Q-R new beam(s) corresponding to a second rule, based on using a second threshold to find the N-Q-R new beam(s) out of the N new beams to be reported as part of the WTRU-IBR.

The WTRU may use computational resources for event determination. For example, the WTRU may use computational resources for determination of one or more of the so-called channel state information (CSI) processing units (CPU) for a duration of time, (e.g., for one or more time units (e.g., symbols, slots, and/or frames)) to determine one or more events, (e.g., a first event, second event, third event, and/or a fourth event). The WTRU may take one or more actions, as described herein. For example, a WTRU may declare or send its capability of determining one or more events to the gNB. For example, a WTRU may declare that it can determine a first event or a second event. A WTRU may declare that it can determine a first event and a second event.

A WTRU may be configured or indicated to use or utilize a one or more CPUs for determination of an event. For example, a WTRU may be configured or indicated to use or utilize O_{CPU}^{CSI}=1 out of the available N CPUs for determination of a first event and O_{CPU}^{CSI}=2 out of the available N CPUs for determination of a second event. For example, a WTRU may be configured or indicated to use or utilize O_{CPU}^{CSI}=4 out of the available N CPUs for determination of a first event and a second event. In an alternative, or additional, example, the number of CPUs needed for determination of an event (e.g., a first event or a second event) may be pre-defined, specified and/or defined as fixed.

A WTRU may use one or more CPUs in one or more time units for determination of one or more events. For example, the WTRU may use O_{CPU}^{CSI}=1 in a number of time units (e.g., in five symbols) to determine a first event. For example, the WTRU may use O_{CPU}^{CSI}=2 in a number of time units (e.g., in three symbols) to determine a second event.

A WTRU may semi-statically or dynamically (e.g., by RRC, MAC-CE, or DCI) receive a configuration of a set of beams, new set of beams, and/or new candidate set of beams for one or more events. For example, the WTRU may receive a first set of beams for a first event. For example, the WTRU may receive a second set of beams for a second event.

The WTRU may receive a second configuration or indication (e.g., using DCI) for a subset of beams, where the subset of beams may be associated with one or more events. For example, the subset of beams may (e.g., may further) be associated with (or may be drawn from) one or more sets of beams, new sets of beams, and/or new candidate sets of beams. For example, the WTRU may receive a DCI. The DCI may include an existing or a new field, and/or may be used for indicated a configured subset of beams to the WTRU. For example, the WTRU may receive a DCI that indicates a first subset of beams. The first subset of beams may be drawn from the first set of beams. The first subset of beams may be for the first event. For example, the WTRU may receive a DCI that indicates a second subset of beams. The second subset of beams may be drawn from the first set of beams and the second subset of beams may be for the second event. For example, the first and the second subset of beams may have one or more common, identical, or exactly the same beams.

The WTRU may determine a first event from a first subset of beams and a second event from a second subset of beams. For example, the WTRU may determine Event-1, where Event-1 can be an indication to indicate that the quality of the current beam is worse than a threshold value. Event-1 may be the index of a beam indicating that the quality of the previous beam was worse than the beam being reported. For example, the WTRU may determine Event-1 and Event-7, where Event-7 indicates that the M_th best activated beam quality became a threshold value worse than a new beam quality. For example, the number of beams in the first subset of beams may be smaller than the number of beams in the second subset of beams. For example, the Event-1 may be determined and reported with a higher periodicity as compared as compared to Event-7.

Resources for reporting of the determined events may be described herein. A WTRU may receive an uplink resource(s) configuration (e.g., PUCCH or PUSCH resources) for reporting the determined events.

For each of the configured and/or determined events, the WTRU may receive a separate resource configuration, and the determined events may be reported independently or separately at different reporting instance. For example, the WTRU may send a first report that includes or contains a first determined event and a second report that includes or contains the second determined event at a first and a second reporting instance, respectively.

A WTRU may receive one or more resource configuration(s), (e.g., PUCCH or PUSCH), intended for transmission, reporting, or sending of the determined events, where one or more events may be transmitted, reported or sent using a single reporting instance and where the resources to be used for transmission or reporting of the determined events at a reporting instance are configured using the corresponding resource configuration. For example, the WTRU may report a first determined event and a second determined event using the time and frequency domain resources configured using the first resource configuration.

A WTRU may also receive indications or configurations associated with a resource configuration for the number and indice(s) of resource unit(s), (e.g., sub-carriers, sub-bands, symbols, or Res) to be used for reporting each of the determined events in each reporting instance. For example, a WTRU may be configured to report a first determined event and a second determined event at a first reporting instance. The WTRU may also be configured to use half of the resources associated with the first reporting instance for sending or reporting the first event and half resources associated with the first reporting instance for sending or reporting the second event. In another example, the WTRU may use a fixed or pre-defined rule or uplink control information (UCI) design or WTRU-IBER indications design to use or utilize a number of resources (e.g., REs) for reporting the determined events.

For example, the total number of candidate beams including the existing or current beam is N (or N−1 excluding the existing or current beam). The WTRU may send an indicator of log₂ N bits to indicate an event, (e.g., Event-1, Event-2, or Event-7). Alternatively, the WTRU may send an indicator of bit-width N bits to indicate an event, where the index of “bit 1” (or alternatively “bit 0”) indicates the beam selected using an Event.

A WTRU may be configured to report one or more events in a CSI report (e.g., in a periodic, aperiodic, and/or semi-persistent CSI report) that includes indications for CSI, (e.g., indications for CSI may include indicators for Rank indicator (RI), precoding matrix indicator (PMI), and/or channel quality indicator (CQI)).

The WTRU may receive an indication to put, report, place, or send one or more of the determined events in a specific sector, portion, segment, and/or part of a CSI report. For example, a WTRU is configured/indicated to report a first event in the first part of a first CSI report and a second event in the second part of the first CSI report. In another example, the WTRU may follow a fixed rule of reporting or sending a first determined event in the first part of a CSI report and a second event in the second part of the first CSI report.

Priority rules for reporting events may be described herein. The WTRU may prioritize (e.g., prioritize the determination and reporting) one or more of first event(s) over one or more of second event(s) and/or other CSI report due to a couple of reasons. The allocated uplink resources for transmission, sending, or reporting of the determined event(s) may not be sufficient to report some or all of the determined events. The allocated uplink resources for transmission, sending, or reporting of the determined events may overlap in at least one time domain and frequency domain unit(s). For example, the uplink resources configured using a first and a second resource configuration for reporting of the determined events may include or contain at least one common, or at least one same frequency domain unit, (e.g., resource element (RE)) at a given time-unit, (e.g., symbol).

The WTRU may assign a priority value to each event using a fixed, pre-defined, configured, and/or indicated rule. For example, the WTRU may be configured to determine a first event and a second event and report it at the first reporting instance. The WTRU may be configured or indicated a rule that may be used to assign a priority value to each of the determined events. In another method, the WTRU may use a fixed rule or pre-defined rule, (e.g., a mathematical equal) to assign a priority value to each of the determined events.

For example, fixed rule, (e.g., an equation, like Pri(i)=Event_ID), may determine an Event_ID, where the Event_ID is the identification ID of an event, (e.g., a first Event has an Event_ID 1, a second Event has an Event_ID 2). The priority value assigned to the determined first event based on the equation may equal Pri (1)=1 and the priority value assigned to the determined second event based on the equation may equal Pri (2)=2.

The WTRU may prioritize the determination and reporting of a first event over a second event, when the first event has a smaller priority value compared to the priority value of the second event. In another example, the WTRU may prioritize the determination and reporting of a first event over a second event, when the first event has a higher priority value compared to the priority value of the second event.

Following or using a priority rule, the WTRU may determine and report Event-1, (e.g., “the current beam quality becomes a threshold value worse than a new beam quality”) with the highest priority. Following or using a priority rule, the WTRU may determine and report Event-2, (e.g., “the current beam quality becomes a threshold value worse than a new beam quality”) with the second highest priority. Following or using a priority rule, the WTRU may determine and report Event-7, (e.g., “the M-th best activated beam quality becomes a threshold value worse than a new beam quality”) with a third highest priority.

In one example, following or using a priority rule, the WTRU may determine and report Event-1, for example, “the current beam quality becomes a threshold value worse than a new beam quality” with the third highest priority. Following or using a priority rule, the WTRU may determine and report Event-2, for example, “the current beam quality becomes a threshold value worse than a new beam quality” with the highest priority. Following or using a priority rule, the WTRU may determine and report Event-7, for example, “the M-th best activated beam quality becomes a threshold value worse than a new beam quality” with a second highest priority.

When the WTRU is configured to report the determined events at a reporting instance and a report that includes indication for other CSI contents, (e.g., indications for CQI, PMI, RI), the WTRU may follow or use a priority rule that assigns higher priority to the determined events compared to the priority values assigned to the indicators of the CSI report, for example, as compared to the priority value assigned to the indicator of CQIs, PMIs, RI, etc.

The WTRU behavior in terms of determination and reporting of the configured Events based on the assigned priority levels to the determined events, may be discussed, summarized and presented using several examples. In an example, when the WTRU is configured or indicated to report Event-1 and Event-2 in a single reporting instance and the WTRU is allocated time and frequency domain resources that are not sufficient for reporting both Event-1 and Event-2 at the reporting instance, the WTRU may drop Event-2 and report Event-1.

In another example, when the WTRU is configured or indicated to report Event-1 and Event-2 in two reporting instances and the resources used at the two reporting instances share at least one common frequency and time domain unit, (e.g., an RE), the WTRU may report Event-1 at a first reporting instance and drop or do not report Event-2 at the second reporting instance.

In another example, when the WTRU is configured to report Event-1, Event-2 and/or Event-7 in a CSI report that includes indications for a determined CSI report, (e.g., the determined CSI report may include indications for CQI, PMI, or RI), the WTRU may use or assign a higher priority value to Event-1, Event-2 and/or Event-7, such that Event-1, Event-2, and/or Event-7 are reported with a higher priority as compared to the remaining contents of the CSI report, (e.g., as compared to CQI, PMI or RI).

The WTRU may change the priority value assigned to an event, or a rule used for assigning priority values to the events based on the number of candidate beams, or new candidate beams (e.g., N) for an event (e.g., a first event, Event-1) and a configured, indicated or fixed threshold associated with the event (e.g., associated with the first event, Event-1).

For example, the WTRU may be configured to report a first event at a first reporting instance and a second event at a second reporting instance. When the number of candidates beams becomes less than a threshold, then instead of bit-padding, for example, zero-padding or one-padding at the first reporting instance to match the number of bits needed at the first reporting instance for reporting, the WTRU may report the second determined event at the first reporting instance instead of waiting for the second reporting instance (for latency reduction) and the WTRU may drop the reporting at the second reporting instance, or repeat the transmission of the second determined event at the second reporting instance (for reliability enhancement).

In another example, the WTRU is configured to report a first event and a second event in a CSI report with two parts where the first event is placed in the first part and the second event is placed in the second part of the CSI report with two parts, when the number of candidate beams or candidate new beams (represented earlier using N) becomes less or smaller than a threshold. The WTRU may place the second determined event along with the first determined event in the first part of the CSI report, when the first part of the CSI report is reported, transmitted or sent at a higher priority as compared to the second part of the CSI report.

Extension to multi-TRP scenario including coherent joint transmission (CJT) cases may be described herein. A WTRU may be configured with mTRP coherent joint transmission (CJT) operation with up to four (e.g., or larger number of) TRPs, while two (e.g., or more as being configured or indicated) are active for CJT WTRU reception. For WTRU reception SNR optimization, the WTRU may be configured to measure and report the relative time/frequency errors between configured TRPs in support for gNB calibration. The CSI-RS resources used for timing and frequency errors tracking may be periodic or aperiodic and the report of the WTRU assistance measurements may be triggered by a relative timing error threshold or a frequency error threshold between the anchor and a secondary TRP or multiple TRPs (candidate for CJT activation TRPs).

When the WTRU assistance for base station calibration is configured, for example, under a CJT operation, the WTRU may be concurrently configured with one or more WTRU-IBR events such as Event-1, Event-2, and/or Event-7. Event-1: “Quality of the current beam is worse than a certain threshold”. Event-2: “Quality of at least new beam, such as L1-RSRP, becomes a threshold better that the current beam. Event-7: “Quality of at least one new beam, such as L1-RSRP, becomes a threshold value better than the RS derived from the activated TCI state with the M-th best quality.

The above listed events may be referring to certain reporting quantities mostly related to a RSRP or SINR of a beam or several beams, while for a CJT scenario there are specific (e.g., additional) requirements related to the coherence transmissions of the active set of TRPs to be received and demodulated by WTRU. CJT may be enhanced to support cases where the TRPs coordinating for CJT are not synchronized due to timing/frequency/phase errors due to non-ideal backhaul and channel conditions. The WTRU may report inter-TRP time/frequency/phase offsets in a standalone CSI report. The WTRU may report quantized value within a configured range of values. The WTRU may report out-of-range or indicate that a measurement is invalid if the WTRU measures a time/frequency/phase offset that is outside the quantization range or if the measurements are unreliable due to poor RS reception (e.g. low SNR/RSRP on the beams of the RS).

Thus, triggering the above listed events, may lead to specific actions while WTRU is operating in a coherent joint transmission (CJT) configuration, due to the nature of WTRU reception of simultaneous beams. SR-ID1, 2, 3, . . . may be Scheduling Requests Identifiers or any specific Tx sequence/signal index/identification (e.g., PUCCH resource ID, as the UL indication resource) that may be associated with a WTRU-IBR event. B1, B2, B3, B4, B5 may represent Beams that may belong to different cell or same cells with same or different QCL properties.

For Event-1, for example, when Event-1 is triggered and the WTRU is receiving coherently from the beam that triggered it, the WTRU may perform a few actions. In an example, the WTRU may be operating with B1 and B2 in coherent CJT reception, and with B3 and B4 configured for CJT as well, for example, where B3 and B4 are not the currently used for CJT, but as a candidate set of beams for CJT. B2 measurement, for example, by the WTRU, may be triggering Event-1. WTRU may transmit SR-ID1 (as the UL indication resource) corresponding to Event-1 for B1 quality. Base Station may order aperiodic or periodic timing and/or frequency and/or phase errors for B3 and B4 as direct beam candidates for CJT active set. WTRU may execute the ordered measurements and reports both or the best/smallest error related to B3 or B4 candidates. The base station may start a frequency and/or timing and/or phase calibration for candidate(s) beam. The WTRU may update the CJT active set for coherence reception with B3 or B4 according to the calibrated beam, for example, based on an indication from the BS and/or determination by the WTRU. The base station may reconfigure the WTRU, dropping the CJT mode for example, or reconfiguring the CJT candidates set with a different partial or complete beam set.

In another example, WTRU may be operating with B1 and B2 in coherent CJT reception with B3 and B4 configured for CJT as well, for example, where B3 and B4 are not the currently used for CJT, but as a candidate set of beams for CJT. B2 may be triggering Event-1 for which the reporting quality is set for timing or frequency error or phase worse than a threshold. In this case, Event-1 may be embedded with these quantities for reporting. Event-1 may have both B2 RSRP worse/better than a threshold and timing or frequency or phase error worse than a threshold, and/or a new event is designated/configured SR-ID4, for example, that may be set for the for timing or frequency or phase error worse than a threshold, while Event-1 definition is maintained. WTRU may be transmitting SR-ID1 or SR-ID4 (as the UL indication resource) corresponding to Event-1 for B1 configured quality report. Base Station may order aperiodic or periodic timing and/or frequency and/or phase errors B3 and B4 as direct beam candidates for CJT active set. WTRU may execute the ordered measurements and may report the errors to base station. The base station may start a frequency and/or timing and/or phase calibration for candidates beam. The WTRU may update the CJT active set for coherence reception with B3 or B4 according to the calibrated beam, for example, based on an indication from the BS and/or determination by the WTRU. The base station may reconfigure the WTRU, dropping the CJT operation mode, or reconfiguring the CJT candidates set with a different partial or complete beam set.

For Event-2, for example, when Event-2 is triggered and the WTRU is receiving coherently from the beam that triggered it, the WTRU may perform a few actions. In an example, WTRU may be operating with B1 and B2 in coherent CJT reception with B3 and B4 configured for CJT as well, for example, where B3 and B4 are not the currently used for CJT, but as a candidate set of beams for CJT. B3 may be triggering Event-2. WTRU may be transmitting SR-ID2 (as the UL indication resource) corresponding to Event-2 for B3 configured quality report. Base Station may order aperiodic or periodic timing and/or frequency and/or phase errors B3 as direct beam candidate for CJT active set/CJT configuration set. The WTRU may execute the ordered measurements and report both or the best/smallest error related B3 candidate.

If the SR-ID2 is for a beam B5 that does not belong to the CJT configured beam set, the base station may reconfigure updating the WTRU CJT beam set with B5, or trigger a handover to the newly reported B5, dropping CJT operation. If the WTRU is transmitting SR-ID2 corresponding to Event-2 for B3, the base station may start a frequency and/or timing and/or phase calibration for candidate beam. The WTRU may update the CJT active set for coherence reception with B1 and B3, for example, based on an indication from the BS and/or determination by the WTRU. If the SR-ID2 is for a beam B5 that does not belong to the CJT configured beam set, the base station may reconfigure updating the WTRU CJT beam set with B5, or trigger a handover to the newly reported B5, dropping CJT operation.

In another example, the WTRU may be operating with B1 and B2 in coherent CJT reception with B3 and B4 configured for CJT as well, for example, where B3 and B4 are not the currently used for CJT, but as a candidate set of beams for CJT. B3 may be triggering Event-2 for which the reporting quality is set for timing or frequency or phase error better than a threshold. In this case, Event-2 may be embedded with these quantities for reporting. The WTRU may be transmitting SR-ID2 (as the UL indication resource) corresponding to Event-2 for B3 quality.

A new event may be designated/configured SR-ID4, for example, while Event-2 definition is maintained or is modified to accommodate other beam index(es), (e.g., B4 as well), for measurement that is set for the for timing or frequency or phase error worse/better than a threshold. WTRU may be transmitting SR-ID2 (as the UL indication resource) corresponding to Event-2 for B3 quality. WTRU may update the CJT active set for coherence reception with B1 and B3 according to the Event-2 reported beam, for example, based on an indication from the BS and/or determination by the WTRU. If SR-ID2 is triggered for a B5 not part of the CJT configured set, the base station may reconfigure updating the WTRU CJT beam set with B5, or trigger a handover to the newly reported B5, dropping CJT operation.

An SR-ID (or PUCCH resource ID, or a new form as the UL indication resource) may be used for combined event triggered reporting. In this case, a codebook may be used if multiple combinations are to be supported. Table 2 illustrates an example of a codebook for a UL indication resource ID signaling for combined events.

TABLE 2
Example of a codebook for a UL indication
resource ID signaling for combined events.

| | Associated SR-ID | | CJT Frequency |
|---|---|---|---|
| | (or PUCCH resource | | or Timing or |
| | ID, or a new form | Beam quantity | Phase error |
| | as the UL indication | Threshold | Threshold (T1, |
| Event-Id | resource) | (SINR, RSRP) | T2 . . . ) |
| Event-1 | 000 | Bi < X | Bi < T1 |
| Event-2 | 001 | Bi > Y | Bi < T1 |
| Event-2-1 | 010 | Bi > Y | Bi > T1 |
| Event-7 | 011 | Bi > Z | Bi < T1 |
| Event-7-1 | 100 | Bi > Z | Bi > T1 |

In the case of Event-7, which can be seen as an Event-2 extension. When triggered for one beam, the actions WTRU takes may be like Event-2 described above for CJT. When triggered for more than one beam, then the actions may follow Event-2 described embodiments for the top quality reported beam, follow a complete reconfiguration of the CJT configured set, or trigger a handover to the top reported beam.

Enhanced group-based beam reporting based on WTRU-IBR may be described herein. In NR, the WTRU may be configured to report CSI for group-based beam reporting for WTRUs that report a capability that supports receiving two beams simultaneously. For example, WTRUs with two panels may receive one beam on a first panel and a second beam simultaneously on a second panel. To support this, a special CSI report configuration may be specified for group-based beam reporting where the WTRU reports the signal quality (e.g., RSRP or SINR) of two beams (e.g., CSI-RS resource index, CRI, or SSB resource index, SSBRI) assuming they are received simultaneously (e.g. for the DL). Group-based reporting may also be configured so that the WTRU reports CRI and SSBRI corresponding to two beams that the WTRU can simultaneously transmit, ULOnly (e.g., for the UL), or simultaneously receive and transmit, JointULandDL (e.g., for DL and UL). Embodiments for simultaneous reception are described herein, and may also apply to group-based beam report configured with ULOnly or JointULandDL without loss of generality.

The WTRU may be configured with two channel measurement resource sets associated to one CSI report, and the WTRU may determine the pairing of beams selected from the two resource sets (e.g., one beam from the first measurement resource set, and a second beam from the second measurement resource set). The pair of resources may be specified as a resource group. The WTRU may select and report up to 4 different resource groups in a single CSI report. The CSI report may be structured as shown in Table 3. Table 3 illustrates CSI report for group-based beam report.

TABLE 3
CSI report for group-based beam report

| CSI | |
|---|---|
| report | |
| number | CSI fields |
| CSI | Resource set indicator |
| report #n | CRI or SSBRI #1 of 1st resource group, if reported |
| | CRI or SSBRI #2 of 1st resource group, if reported |
| | CRI or SSBRI #1 of 2nd resource group, if reported |
| | CRI or SSBRI #2 of 2nd resource group, if reported |
| | CRI or SSBRI #1 of 3rd resource group, if reported |
| | CRI or SSBRI #2 of 3rd resource group, if reported |
| | CRI or SSBRI #1 of 4th resource group, if reported |
| | CRI or SSBRI #2 of 4th resource group, if reported |
| | RSRP of CRI or SSBRI #1 of 1st resource group |
| | Differential RSRP of CRI or SSBRI #2 of 1st resource group |
| | Differential RSRP of CRI or SSBRI #1 of 2nd resource group |
| | Differential RSRP of CRI or SSBRI #2 of 2nd resource group |
| | if reported |
| | Differential RSRP of CRI or SSBRI #1 of 3rd resource group |
| | if reported |
| | Differential RSRP of CRI or SSBRI #2 of 3rd resource group |
| | if reported |
| | Differential RSRP of CRI or SSBRI #1 of 4th resource group |
| | if reported |
| | Differential RSRP of CRI or SSBRI #2 of 4th resource group |
| | if reported |

The resource set indicator, as shown in Table 3, may be a 1-bit index that maps the 1st CRI or SSBRI of a resource group (e.g., denoted by the CRI or SSBRI #1 of 1st resource group) to either the first or second channel measurement resource set. For example, the WTRU may be configured with two CSI-RS resource sets. If the WTRU reports that the resource set indicator is 0, the CRI #1 of each resource group in the report may correspond to a resource index from the first measurement resource set, and CRI #2 of each resource group may correspond to a resource index from the second measurement resource set. If the WTRU reports that the resource set indicator is 1, the CRI #1 of each resource group may correspond to a resource index from the second measurement resource set, and CRI #2 of each resource group may correspond to a resource index from the first measurement resource set. Based on this reporting of the resource set indicator, the WTRU may further encode the differential RSRP values (e.g., each 4 bits) according to a reference RSRP value (e.g., 7 bits) of CRI or SSBRI #1 of 1st resource group that is pointed by the resource set indicator. In other words, the WTRU may select the highest RSRP for CRI #1 of the first resource group which could be from either resource set #1 or #2, that is indicated by the reported resource set indicator.

The discussed WTRU-IBR procedure may be at least for a single measurement resource set. If the WTRU is configured with two measurement resource sets for group-based beam reporting, the WTRU may have to send two separate WTRU-IBR (one per resource set) which may be inefficient and may not support WTRUs that have additional capabilities to indicate beam pairs for simultaneous beam reception.

WTRU-IBR for group-based beam reporting with event conditions per measurement set is described herein. In an example, the WTRU-IBR may be configured based on multiple measurement sets, for example, for group-based reporting (GB-WTRU IBR), where the (GB-WTRU IBR) may share a similar structure to Table 3. The triggers based on the multiple measurement sets (e.g., for the group-based reporting, each set for being used for different assumption, scenario, or hypothesis being pre-defined or configured, (e.g., different symbol type due to different interference nature such as full duplexing scenario)) may be configured per resource set (e.g., Event-1, Event-2, Event-4, Event-7). For example, Event-1 is triggered for each measurement resource set if a current beam quality from each measurement resource set becomes worse than a threshold configured per each measurement resource set. Hereinafter, the terminology of GB-WTRU IBR is for an exemplary purpose, and any different scenario, assumption, or hypothesis may be applicable, used, applied based on configuring multiple measurement sets in combination with the WTRU-IBR procedure. The WTRU may send a GB-WTRU IBR depending on whether one or both measurement resource set events are triggered.

The WTRU may send a GB-WTRU IBR if one of the trigger conditions for either resource set is satisfied. For example, the WTRU may send a GB-WTRU IBR if Event-1 is triggered for the first measurement resource set (regardless if the second measurement set is triggered).

In another example, the WTRU may send a GB-WTRU IBR if the same trigger conditions are satisfied for both measurement resource sets. For example, the WTRU may send a GB-WTRU IBR if Event-1 is triggered on both measurement resource sets.

The WTRU may be configured with different triggering conditions per measurement resource set. For example, the WTRU may be configured with Event-1 condition for the first measurement resource set, and Event-2 for the second measurement resource set. The WTRU may send the GB-WTRU IBR if either of the event conditions is met. A new field in the CSI report may be used to indicate which of the event conditions triggered the GB-WTRU IBR. For example, if N=2 conditions are configured in this case (Event-1 and Event-2). The GB-WTRU IBR may include a log 2(N)=1 bit indicator where 0 indicates that the GB-WTRU IBR is triggered because of Event-1, and 1 indicates that that the GB-WTRU IBR is triggered because of Event-2. If multiple events are configured per measurement resource set, log 2(N) bits may be required to map a codepoint one-to-one with an event. In another example, the WTRU may implicitly indicate the measurement resource set with the triggered condition through the resource set indicator. If multiple events are configured per measurement resource set, the network may determine that any of the measurement conditions associated with the resource set indicator may have caused the GB-WTRU IBR trigger.

WTRU-IBR for group-based beam reporting with event conditions across measurement resource sets may be described herein. In one example, a new trigger event may be defined as a condition for the WTRU to report a GB-WTRU IBR where one or more new events may be defined based on the difference in channel quality between resources in different measurement sets or between resource groups. One or more of the events may be configured for GB-WTRU IBR where delta may be a configured threshold for each of these events.

A GB-WTRU IBR may be triggered if the WTRU determines that the RSRP difference between the highest RSRP in different measurement resource sets is below a threshold. For example, the event condition may be triggered if (RSRP_max1-RSRP_max2)>delta where RSRP_max1 and RSRP_max2 are the highest RSRPs from measurement resource set 1 and 2.

A GB-WTRU IBR may be triggered if the WTRU determines that the RSRP difference between resources in one previously reported resource group is below a threshold. For example, the WTRU may send a CSI report for group-based beam report with a first resource group where the RSRP of the resource pair is delta_group1=RSRP of CRI #1-RSRP of CRI #2. The WTRU may monitor the channel quality of the first resource group. If delta_group 1>delta, the event condition is triggered.

A GB-WTRU IBR may be triggered if the WTRU determines that the average RSRP difference between resources in different measurement resource sets is below a threshold. For example, the event condition may be triggered if (RSRP1_avg-RSRP2_avg)>delta where the average RSRP from resources in the first and second measurement resource set are RSRP1_avg and RSRP2_avg, respectively.

A GB-WTRU IBR may be triggered if the WTRU determines that a new beam pair is greater than the threshold of one of the previously M=4 reported beam pairs where M is the configurable number of resource groups. For example, the WTRU reported a first resource group with delta_group1=(RSRP of CRI #1-RSRP of CRI #2 from resource group 1). The event condition may be triggered if the WTRU determines that a different resource group with delta_group2=(RSRP of CRI #1-RSRP of CRI #2 from resource group 2) is greater than delta_group1. The new beam pair may also correspond to a new beam pair that the WTRU determined from the measurement resource sets and that the WTRU has not previously reported.

A GB-WTRU IBR may be triggered if the WTRU determines the number of beam pairs satisfying a condition (e.g., where the RSRPs of the beams are both above a threshold, or the RSRP of at least one beam in the pair is above a threshold) is below a threshold. For example, the WTRU may find one beam pair amongst the M possible combinations where the RSRP of both beams is above a threshold. The threshold for the number of beam pairs is configured as M/2. Since the WTRU could find 1<M/2 beam pairs, then the event condition may be triggered.

Timers to prevent sending multiple WTRU-IBR and GB-WTRU IBR reports are described herein. The WTRU may be configured with both a regular WTRU-IBR (e.g., without group-based beam report) and a GB-WTRU IBR. A timer may be configured (e.g., a periodic timer or prohibit timer) after the WTRU reports a WTRU-IBR or GB-WTRU IBR. The timer may be used to avoid reporting multiple WTRU-IBR or GB-WTRU IBR that may be triggered within a period of time, or avoid reporting an WTRU-IBR and a GB-WTRU IBR that may be triggered by the same event condition within a period of time.

Separate timers may be configured, one for WTRU-IBR and one for GB-WTRU IBR, or a same timer may be configured and starts from the last beam report (e.g., WTRU-IBR or GB-WTRU IBR). The WTRU may trigger a WTRU-IBR or GB-WTRU IBR after the timer expires, where the WTRU starts the timer on the slot where it last sent a WTRU-IBR or GB-WTRU IBR.

The timer may be associated with an event condition for triggering a WTRU-IBR or GB-WTRU IBR. For example, if both the WTRU-IBR and GB-WTRU IBR are configured with the same event type (e.g., Event-2) where the same measurement resource set is configured in WTRU-IBR and GB-WTRU IBR, the WTRU may trigger an WTRU-IBR or GB-WTRU IBR after the timer expires since the WTRU last reported a WTRU-IBR or GB-WTRU IBR triggered by Event-2.

1. A wireless transmit/receive unit (WTRU) comprising a processor configured to:
receive configuration information, wherein the configuration information indicates a plurality of measurement events, and wherein each of the plurality of measurement events is associated with both an UL indication resource and a measurement report resource;
detect a triggering condition for at least one measurement event of the plurality of measurement events based on an applicable event definition in the configuration information;
determine, in response to the triggering condition being detected, an UL indication resource associated with the at least one measurement event in the configuration information;
transmit, to a base station, an indication on the UL indication resource to indicate the detection of the triggering condition for the at least one measurement event; and
transmit, to the base station, a measurement report on a first available transmission occasion of a measurement report resource associated with the at least one measurement event in the configuration information.

2. (canceled)

3. The WTRU of claim 1, wherein the is configured to:
transmit, the measurement report in response to the transmission of the indication on the UL indication resource.

4. The WTRU of claim 1, wherein the measurement report comprises one or more beam quality metrics, or a channel state information (CSI).

5. The WTRU of claim 1, wherein the UL indication resource is a physical uplink control channel (PUCCH) resource.

6. (canceled)

7. The WTRU of claim 1, wherein the transmission on the UL indication resource comprises one bit or two bits.

8. The WTRU of claim 1, wherein at least one of the plurality of measurement events comprises an event for checking whether a current beam quality is lower than a threshold.

9. (canceled)

10. The WTRU of claim 1, wherein at least one of the plurality of measurement events comprises at least one of: (i) an event for checking whether a current beam quality is lower than a new beam quality; or (ii) an event for checking whether a M-th best activated beam quality is lower than a new beam quality, wherein a value of M is configured.

11. A method performed by a wireless transmit/receive unit (WTRU), the method comprising:
receiving configuration information, wherein the configuration information indicates a plurality of measurement events, and wherein each of the plurality of measurement events is associated with both an UL indication resource and a measurement report resource;
detecting a triggering condition for at least one measurement event of the plurality of measurement events based on an applicable event definition in the configuration information;
determining, in response to the triggering condition being detected, an UL indication resource associated with the at least one measurement event in the configuration information;
transmitting, to a base station, an indication on the UL indication resource to indicate the detection of the triggering condition for the at least one measurement event; and
transmitting, to the base station, a measurement report on a first available transmission occasion of a measurement report resource associated with the at least one measurement event in the configuration information.

12. (canceled)

13. The method of claim 11, further comprising:
transmitting, the measurement report in response to the transmission of the indication on the UL indication resource.

14. The method of claim 11, wherein the measurement report comprises one or more beam quality metrics, or a channel state information (CSI).

15. The method of claim 11, wherein the UL indication resource is a physical uplink control channel (PUCCH) resource.

16. (canceled)

17. The method of claim 11, wherein the transmission on the UL indication resource comprises one bit or two bits.

18. The method of claim 11, wherein at least one of the plurality of measurement events comprises an event for checking whether a current beam quality is lower than a threshold.

19. (canceled)

20. The method of claim 11, wherein at least one of the plurality of measurement events comprises at least one of: (i) an event for checking whether current beam quality is lower than a new beam quality; or (ii) an event for checking whether a M-th best activated beam quality is lower than a new beam quality, wherein a value of M is configured.

21. The WTRU of claim 1, wherein the CSI comprises indications for rank indicator (RI), precoding matrix indicator (PMI), or channel quality indicator (CQI).

22. The WTRU of claim 1, wherein the measurement report resource is a physical uplink shared channel (PUSCH) resource.

23. The WTRU of claim 1, wherein the processor is configured to receive an indication to apply a mode B WTRU initiated beam reporting.

24. The method of claim 11, wherein the CSI comprises indications for rank indicator (RI), precoding matrix indicator (PMI), or channel quality indicator (CQI).

25. The method of claim 11, wherein the measurement report resource is a physical uplink shared channel (PUSCH) resource.

26. The method of claim 11, further comprising receiving an indication to apply a mode B WTRU initiated beam reporting.
